(19) United States
(12) Patent Application Publication
(10) Pub. No.: US 2003/0080711 A1
(43) Pub. Date: May 1, 2003

(54) Electrical power generation system and method therefor

(76) Inventor: William E. Stearns, Lake Havasu City, AZ (US)

Correspondence Address: WEISS & MOY PC, 4204 NORTH BROWN AVENUE, SCOTTSDALE, AZ, 85251, US

(21) Appl. No.: 10/015,145

(22) Filed: Oct. 26, 2001

(51) Int. Cl. H02J 7/00

(52) U.S. Cl. 320/101

(57) ABSTRACT

A self generating electrical power unit which does not require an outside power source. The self generating power unit has a battery for supplying an initial starting power. A control box is coupled to the battery and is used for converting the initial starting power and for switching the distribution of power within the self generating electrical power unit. A motor is coupled to the control box. A generator is coupled to and powered by the motor.

### BACKGROUND OF THE INVENTION

1. Field of the Invention

This invention relates generally to an electrical power generation system, and more specifically, to a self generating electrical power unit and a method therefor.

2. Background of the Invention

Electric power for residential and commercial use is typically produced by extremely large generators in electric power plants. These generators are commonly driven by fossil fuels or nuclear energy sources. Fossil fuels include oil, natural gas and coal. Unfortunately, fossil fuels and nuclear fuels are not environmentally friendly. Power plants utilizing fossil fuels produce air pollution and greenhouse gases. Power plants utilizing nuclear fuels produce radioactive wastes. The radioactive waste must be stored for long periods of times before they are no longer harmful to the environment. Unfortunately, there is no where to safely store the nuclear waste without the potential for spillage which would drastically harm the environment.

In areas which are not serviced by electric power plants, small portable generators are often used to provide a source of electric power. These portable generators generally comprise a small fossil fuel engine coupled to a generator. Unfortunately, such systems also generate polluting emissions that are undesirable. Furthermore, these portable generators cannot run for extended periods of time without having to be refueled.

Therefore, a need existed to provide an improved electrical power system that does not suffer from the above mentioned problems. The improved electrical power system must be environmentally friendly. The improved electrical power system must further be able to run for long periods of time without having to be refueled.

### SUMMARY OF THE INVENTION

In accordance with one embodiment of the present invention, it is an object of the present invention to provide an improved electrical power system,

It is another object of the present invention to provide an improved electrical power system that is environmentally friendly.

It is still another object of the present invention to provide an improved electrical power system that is capable of running for long periods of time without having to be refueled.

### BRIEF DESCRIPTION OF THE PREFERRED EMBODIMENTS

In accordance with one embodiment of the present invention, a self generating electrical power unit is disclosed. The self generating power unit has a battery for supplying an initial starting power. A control box is coupled to the battery and is used for converting the initial starting power and for switching the distribution of power within the self generating electrical power unit. A motor is coupled to the control box. A generator is coupled to and powered by the motor. The control box may comprise an inverter and switches. The inverter is used for converting the initial starting power from the battery to an alternating current power. The switches are coupled to the motor and the generator and are used for transferring the alternating current power to the motor and for routing power generated from the generator back to the motor.

In accordance with another embodiment of the present invention, a method of providing Et self generating electrical power unit is disclosed. The method comprises the steps of: providing a battery for supplying an initial starting power; providing a control box coupled to the battery for converting the initial starting power and for switching the distribution of power within the self generating electrical power unit; providing an inverter within the control box; providing a sensor/start switch within the control box; coupling a motor to the control box; coupling a generator to the motor; transferring the initial staring power from the battery to the inverter; converting the initial staring power to an alternating current power; transferring the alternating current power to the motor to drive the motor; transferring energy generated by the motor to the generator; routing energy generated from the generator back to the motor.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiment when read in conjunction with the accompanying drawings, wherein like reference numerals and symbols represent like elements.

FIG. 1 is a simplified functional block diagram of one embodiment of the Self Generating Electrical Power Unit of the present invention.

FIG. 2 is a simplified functional block diagram of another embodiment of the Self Generating Electrical Power Unit of the present invention.

### DETAILED DESCRIPTION

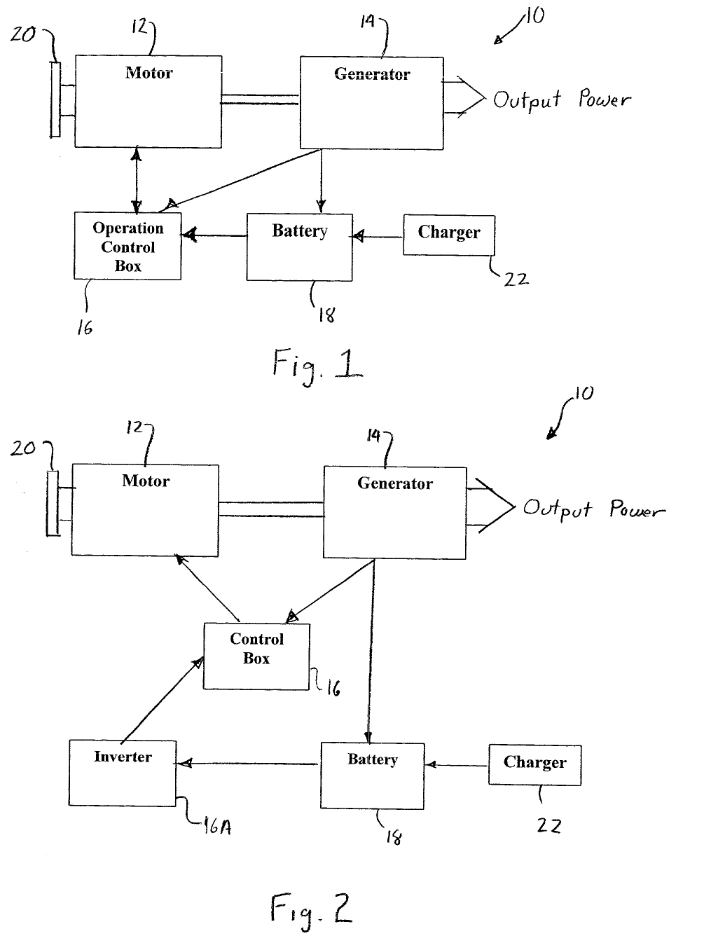

Referring now to the FIG. 1, a self generating electrical power unit 10 (hereinafter power unit 10) is shown. The power unit 10 requires no outside sources of power. Thus, fuels like oil, natural gas, nuclear fuel, wind, and the like are not required to run the power unit 10. Since no outside fuel sources are necessary, the power unit 10 produces minimal amounts of pollution and thus does not harm the environment. Furthermore, the power unit 10 dramatically reduces the amount of noise pollution as compared to current gas and diesel engines.

The power unit 10 is comprised of four main components. They are an electric motor 12, a generator 14, a control box 16, and a battery 18. The battery 18 is used to supply initial starting power. The battery 18 may be of various different sizes. The size of the battery 18 will depend on the size of the motor 12 which the batter is sued to start.

The battery 18 is coupled to a control box 16. The control box 16 generally houses an inverter and switches. The switches may include a sensor/start switch and an on/off switch. Power is supplied from the battery 18 to the inverter. The inverter, coverts the low voltage DC power to an AC power. The AC power flows through the sensor/start switch to the motor 12 thereby starting the motor 12. When started, the motor 12 will drive the generator 14. In the embodiment depicted in FIG. 1, the motor 12 will drive the generator 14 via a drive shaft 20.

When the generator is up to speed, the AC power is routed back through the sensor/start switch to the motor 12. When the sensor/start switch senses the AC power flowing from the generator 14 for a predetermined time period, the sensor/start switch will open thereby disconnecting power from the inverter to the motor 12. The motor 12 will now run on power flowing from the generator 14. The power unit 10 will now run on it's own power until being shut down by the turning off of the power unit 10 via the on/off switch or until one of the components fail.

The battery 18 may be a rechargeable battery 18. Power from the generator 14 may be used to recharge the battery 18. Alternatively, a solar panel 22 or another type of recharging apparatus may be used.

A pulley 20 may be coupled to the motor 12. The pulley 20 will allow alternative pieces of equipment or articles to be drives by the motor 12 when the power unit 10 is operational.

It should be noted that two or more power units 10 coupled be coupled together. Thus, the control box 16 and the battery 18 would not be required in these embodiments. Power from one generator 14 coupled be sent to start the motor 12 of another power unit 10.

Referring now to FIG. 2 wherein like numerals and symbols represent like elements, another embodiment of the power unit 10 is shown. The power unit 10 in FIG. 2 is the same as that shown in FIG. 1. The main difference is that the inverter 16A has been separated from the control box 16. It should be noted that the inverter 16A may not be necessary if the motor 12 is a low voltage DC motor.

The power unit 10 is advantageous over prior art units since it needs no outside source of power. The power unit may be built in various sizes from small portable units to large power generators.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A self generating electrical power unit comprising, in combination:
a battery for supplying an initial starting power;
a control box coupled to the battery for converting the initial starting power and for switching the distribution of power within the self generating electrical power unit;
a motor coupled to the control box; and
a generator coupled to and powered by the motor.

2. A self generating electrical power unit in accordance with claim 1 wherein the control box comprises:
an inverter for converting the initial starting power from the battery to an alternating current power; and
a sensor/start switch coupled to the motor and the generator for transferring the alternating current power to the motor and for routing power generated from the generator back to the motor.

3. A self generating electrical power unit in accordance with claim 1 further comprising a drive shaft coupled to the motor and the generator for transferring power from the motor to the generator.

4. A self generating electrical power unit in accordance with claim 1 further comprising a charger coupled to the battery for recharging the battery.

5. A self generating electrical power unit in accordance with claim 4 wherein the charger coupled to the battery is a solar panel.

6. A self generating electrical power unit comprising, in combination:
a battery for supplying an initial starting power;
a control box for converting the initial starting power and for switching the distribution of power in the self generating electrical power unit;
a motor coupled to the control box;
a generator; and
a drive shaft coupled to the motor and the generator for transferring power from the motor to the generator;
wherein the control box comprises:
an inverter for converting the initial starting power from the battery to an alternating current power; and
a sensor/start switch coupled to the motor and the generator for transferring the alternating current power to the motor and for routing power generated from the generator back to the motor.

7. A self generating electrical power unit in accordance with claim 6 further comprising a charger coupled to the battery for recharging the battery.

8. A self generating electrical power unit in accordance with claim 7 wherein the charger coupled to the battery is a solar panel.

9. A method of providing a self generating electrical power unit comprising the steps of:
providing a battery for supplying an initial starting power;
providing a control box for converting the initial starting power and for switching the distribution of power within the self generating electrical power unit;
providing an inverter within the control box;
providing a sensor/start switch within the control box coupling a motor to the control box;
coupling a generator to the motor;
transferring the initial staring power from the battery to the inverter;
converting the initial staring power to an alternating current power;
transferring the alternating current power to the motor to drive the motor;
transferring energy generated by the motor to the generator;
routing energy generated from the generator back to the motor.

10. The method of claim 9 wherein the step of routing energy generated from the generator back to the motor further comprises:
routing the energy generated from the generator to the sensor/start switch;
monitoring the energy generated from the generator at the sensor/start switch; and
opening the sensor start switch to route the energy generated from the generator back to the motor when power from the generator reaches a predetermined value and flows for a predetermined time period.
